(19) United States
(12) Patent Application Publication
(10) Pub. No.: US 2013/0226713 A1
(43) Pub. Date: Aug. 29, 2013

(54) BID DISCOUNTING USING EXTERNALITIES

(71) Applicants: Sreenivas Gollapudi, Cupertino, CA (US); Anand Bhalgat, Philadelphia, PA (US)

(72) Inventors: Sreenivas Gollapudi, Cupertino, CA (US); Anand Bhalgat, Philadelphia, PA (US)

(73) Assignee: Microsoft Corporation, Redmond, WA (US)

(21) Appl. No.: 13/407,739

(22) Filed: Feb. 28, 2012

(51) Int. Cl. G06Q 30/02; G06Q 30/08

(52) U.S. Cl. 705/14.71

(57) ABSTRACT

Advertisers provide bids for the placement of one or more advertisements on web pages, along with a set of externalities. The externalities from an advertiser indicate discounts that can be applied to their bid based on information learned from a browse history of a user. The externalities may include externalities based on previous viewings of advertisements from the advertiser by the user, externalities based on previous viewings of advertisements from competitor advertisers viewed by the user, and externalities based on web pages or domains that have been visited by the user. When a request for an advertisement is received, the externalities are used to discount the provided bids based on the browse history of the user. An advertisement is then selected based on the discounted bids.

### BACKGROUND

The increasing amount of time a user spends online conducting e-commerce transactions has led to a widespread use of online advertising by merchants to attract potential customers to their sites and/or products. Often, this shopping experience of the user extends beyond his query to a search engine and includes visiting multiple web sites to learn more about the product. Further, this browse session of the user is interspersed with multiple threads of activities. Thus, user browsing behavior on the web encodes a lot of contextual information about the user that can be used for matching advertisements to the user.

Current behavioral retargeting systems gather information about the user as he browses the Internet and use this information to obtain advertisements from interested advertisers and display them on subsequent web sites a user visits on the Internet. In this case, the matching of advertisements to a user is done in the traditional way of soliciting bids from the advertisers that encapsulate the value placed by the advertiser on the user profile. Such profiles typically represent past activity of the user on the Internet. However, in current systems the valuation an advertiser places on a user profile is too simplistic to incorporate externalities of the past user behavior on the advertiser's valuation of the user.

### SUMMARY

Advertisers provide bids for the placement of one or more advertisements on web pages. Externalities associated with the advertisers are received. The externalities for an advertiser indicate discounts that can be applied to their bid based on information learned from a browse history of a user. The externalities may include externalities based on previous viewings of advertisements from the advertiser by the user, externalities based on previous viewings of advertisements from competitor advertisers by the user, and externalities based on web pages or domains that have been visited by the user. When a request for an advertisement is received, the externalities are used to discount the provided bids based on the browse history of the user. An advertisement is then selected based on the discounted bids.

In an implementation, for each of a plurality of advertisers, a bid is received for each of a plurality of web pages at a computing device. For each of the advertisers, a set of externalities associated with the advertiser is received at the computing device. An identifier of a web page from the plurality of web pages and browse session data are received. For each of the advertisers, the received bid for the identified web page from the advertiser is discounted based on the set of externalities associated with the advertiser and the browse session data. The discounted received bids are provided by the computing device.

In an implementation, an identifier of a web page and browse session data are received at a computing device. Bids corresponding to the identified web page are received by the computing device. Each bid is associated with an advertiser. For each advertiser, a set of externalities associated with the advertiser is retrieved by the computing device. For each advertiser, the bid associated with the advertiser is discounted based on the set of externalities associated with the advertiser and the browse session data. A maximum discounted bid is determined. An advertisement associated with the advertiser associated with the determined maximum discounted bid is selected by the computing device. The selected advertisement is provided by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for discounting bids using externalities;

FIG. 2 is an illustration of an example browse graph;

FIG. 3 is an illustration of an example bid graph;

FIG. 4 is an illustration of an example competitor graph;

FIG. 5 is an operational flow of an implementation of a method for discounting bids based on externalities;

FIG. 6 is an operational flow of an implementation of another method for discounting bids based on externalities; and

FIG. 7 is a block diagram of a computing system environment according to an implementation of the provided system.

### DETAILED DESCRIPTION

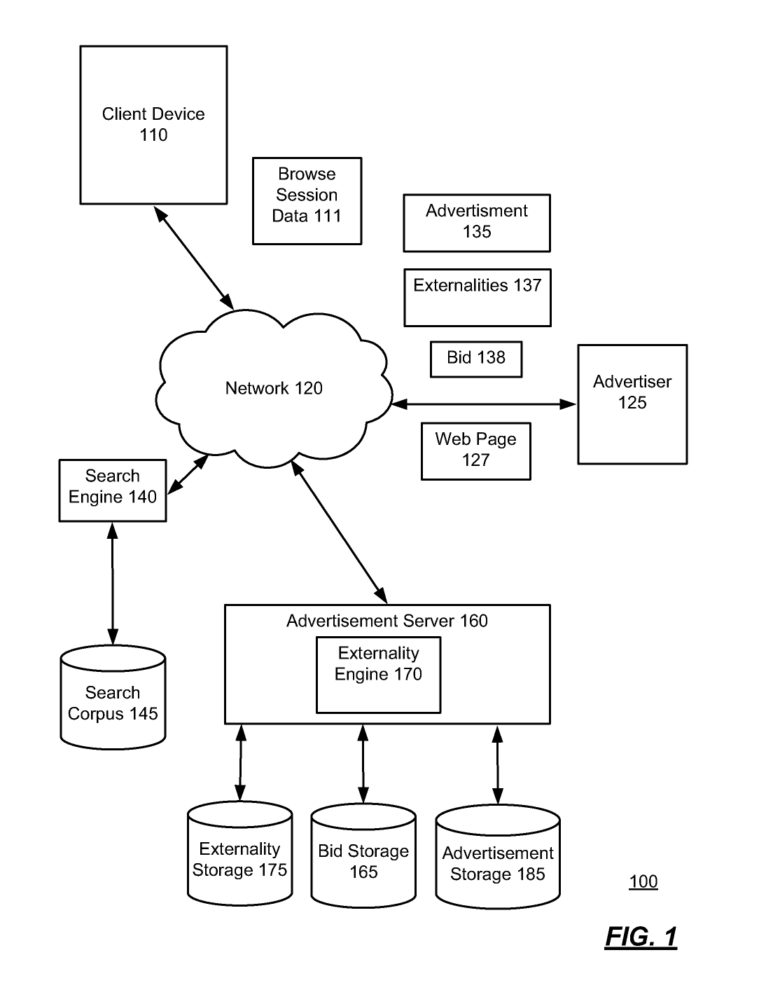

FIG. 1 is an illustration of an example environment 100 for discounting bids using externalities. A client device 110 may communicate with one or more search engines 140, advertisers 125, and advertisement servers 160 through a network 120. The client device 110 may be configured to communicate with the search engines 140, advertisers 125, and advertisement servers 160 to access, receive, retrieve and display media content and other information such as web pages and advertisements. The network 120 may be a variety of network types including the public switched telephone network (PSTN), a cellular telephone network, and a packet switched network (e.g., the Internet).

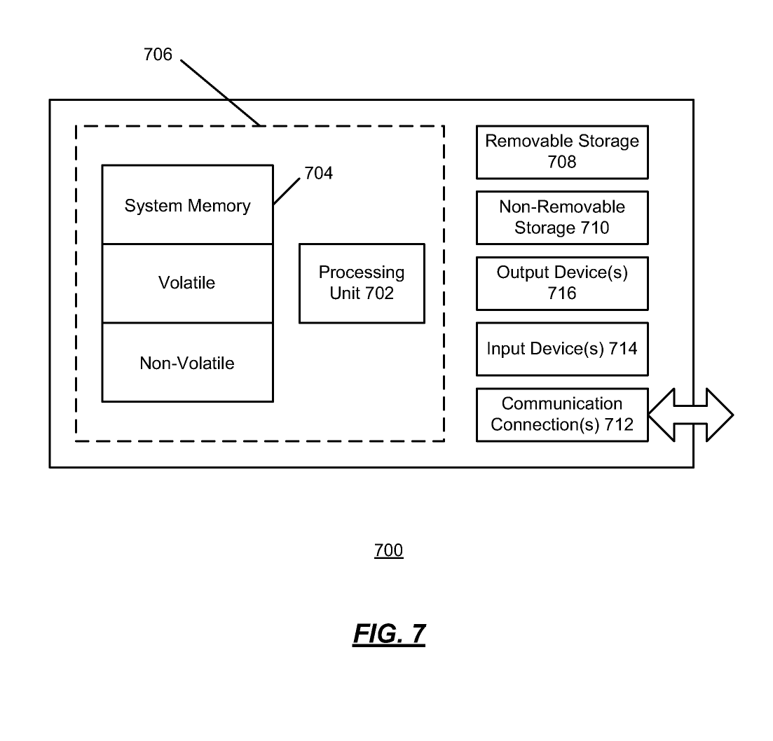

In some implementations, the client device 110 may include a desktop personal computer, workstation, laptop, PDA, smart phone, cell phone, or any WAP-enabled device or any other computing device capable of interfacing directly or indirectly with the network 120. The client device 110 may run an HTTP client, e.g., a browsing program, such as MICROSOFT INTERNET EXPLORER or other browser, or a WAP-enabled browser in the case of a cell phone, PDA or other wireless device, or the like. The client device 110 may be implemented using a general purpose computing device such as the computing device 700 illustrated in FIG. 7, for example.

The advertiser 125 may be configured to provide web pages 127 responsive to requests received from users using devices such as the client device 110. The advertiser 125 may also allow users to search for, view, and purchase a variety of products or services through one or more web pages 127 associated with various products and services. For example, the advertiser 125 may be an electronics provider and users may browse and search for electronics available from the electronics provider by requesting one or more web pages 127 available at the advertiser 125.

The search engine 140 may be configured to receive queries from users using clients such as the client device 110. The search engine 140 may search for media responsive to the query by searching a search corpus 145 using the received query. The search corpus 145 may be an index of media such as web pages 127 (e.g., web pages 127 from the advertisers 125), product descriptions, image data, video data, map data, etc. The search engine 140 may generate and return links to web pages 127 to the client device 110 using the search corpus 145.

The advertiser 125 may further generate one or more advertisements 135. The advertisements 135 may be advertisements for one or more products or services available from the advertiser 125. The advertisements 135 may include a variety of advertisement types such as image or video advertisements 135. The advertisements 135 may be generated by the advertiser 125 for placement on one or more web pages 127.

The advertiser 125 may provide the advertisements 135 to the advertisement server 160. The advertisement server 160 may store the advertisements 135 in the advertisement storage 185. The advertisement server 160 may then receive a request for an advertisement 135 for placement on a web page 127, and may provide an advertisement 135 from the advertisement storage 185 in response to the request. For example, a web page 127 provided by an advertiser 125 or a search engine 140 may include code that when processed by the client device 110 causes the client device 110 to request an advertisement 135 from the advertisement server 160. The advertisement server 160 may then provide an advertisement 135 to the client device 110, and the client device 110 may then display the advertisement 135 in the web page 127 to a user of the client device 110. The advertisement server 160 may be implemented using a general purpose computing device such as the computing device 700 illustrated in FIG. 7, for example.

Typically, an advertiser 125 may provide the advertisements 135 along with one or more bids 138 to the advertisement server 160. The advertisement server 160 may store the bids 138 in the bid storage 165. A bid 138 may be associated with a web page 127, and may be the highest bid that a particular advertiser 125 is willing to pay for a user click or selection of their advertisement 135 on a web page 127. When a request for an advertisement 135 is received for a web page 127 by the advertisement server 160, the advertisement server 160 selects the advertisement 135 for the web page 127 with the greatest bid 138. The selected advertisement 135 may then be provided for placement on the web page 127.

As described above, one drawback associated with current methods for selecting advertisements using bids is that they fail to take into account externalities 137 associated with each advertiser 125. Accordingly, in some implementations, the advertisement server 160 further includes an externality engine 170. The externality engine 170 may receive one or more externalities 137 from each advertiser 125 along with their bids 138, and may store the received externalities 137 in the externality storage 175. In some implementations, the one or more externalities 137 may be generated for each advertiser 125. When a request for an advertisement 135 is received for a web page 127 by the advertisement server 160, the externality engine 170 may discount the stored bids 138 for each advertiser 125 based on one or more externalities 137 associated with each advertiser 125. In an implementation, the externality engine 170 may identify the advertisement 135 associated with the maximum discounted bid, and the advertisement server 160 may then provide the identified advertisement 135 for placement on the web page 127.

In some implementations, the externalities 137 may be negative, and may be used to discount the bids 138 based on browse session data 111 associated with a user. The browse session data 111 may include a browse history of the user, and may include indicators of web pages 127 that the user has visited during the browse session, along with indicators of advertisements 135 that were presented to the user during the browse session. The browse session data 111 may correspond to a current search session of the user, or may be a combination of several search sessions of the user. Alternatively, the browse session data 111 may identify only a subset of the web pages 127 visited and advertisements 135 viewed by the user during the search session. For example, the browse session data 111 may include identifiers of the last five web pages 127 viewed by the user, and the last five advertisements 135 viewed by the user.

In some implementations, the browse session data 111 may be collected by a toolbar or other browser component of the client device 110, and may be provided to the advertisement server 160 along with a request for an advertisement 135. A user may be asked to “opt-in” or otherwise consent that they want their browse session data 111 to be provided to the advertisement server 160 before any data is transmitted to the advertisement server 160. Moreover, any data that can be used to identify the user from the browse session data 111 may be removed or otherwise obscured before the browse session data 111 is provided.

In some implementations, the externalities 137 provided by an advertiser 125 may include externalities 137 related to advertisements 135 of the advertiser 125 itself that have been viewed by a user during the browse session, externalities 137 related to advertisements 135 from competitors of the advertiser 125 that have been viewed by the user during the browse session, and externalities 137 related to domains or web pages 127 that the user has visited during the browse session. Other types of externalities 137 may be used.

The externalities 137 related to advertisements 135 from the advertiser 125, or generated for the advertiser 125, may represent the diminishing returns associated with repeatedly showing the same or similar advertisement 135 to a user. For example, during a browsing session a user may be shown an advertisement 135 associated with a particular brand of shoe. If the user is later shown an advertisement 135 for the same brand of shoe, the advertisement 135 may be less effective because the user has already viewed and considered the advertisement 135. Accordingly, an advertiser 125 may provide an externality 137 that discounts a bid 138 to show an advertisement 135 on a web page 127 if the advertisement 135, or a related advertisement 135, has already been shown to a user in a browse session as indicated by the browse session data 111.

The externalities 137 related to advertisements 135 of competitors of the advertisers 125 may represent the reduced effectiveness of showing an advertisement 135 to a user after the user has seen an advertisement 135 associated with a competitor advertiser. Continuing the example from above, during a browsing session a user may be shown an advertisement 135 associated with a particular brand of shoe that is from a competitor of the advertiser 125. If the user is later shown an advertisement 135 for a shoe from the advertiser 125, the advertisement 135 may be less effective because the user has already viewed and considered the advertisement 135 for the competing shoe. Accordingly, an advertiser 125 may provide an externality 137 that discounts a bid 138 to show an advertisement 135 on a web page 127 if an advertisement 135 from a competitor has already been shown to a user in a browse session as indicated by the browse session data 111.

The externalities 137 related to domains or web pages 127 that a user has visited may represent the reduced effectiveness of showing an advertisement 135 to a user after the user has visited particular domains or particular web pages 127. For example, an advertisement 135 may be less effective after a user has been to a web page 127 or domain associated with a competitor of the advertiser 125. Accordingly, an advertiser 125 may provide an externality that discounts a bid to show an advertisement 135 on a web page 127 if a user has visited a web page 127 or domain associated with a competitor as indicated by the browse session data 111.

Each advertiser may receive identifiers of web pages 127 from the advertisement server 160. The advertisers may then generate bids 138 for the identified web pages. In some implementations, the identifiers of web pages 127 may be represented as a browse graph. A browse graph may include a node for each web page 127 that a user may visit during a search session. The nodes may be connected with directed edges that represent the sequence of web pages 127 that the user visits. Each edge may have an associated weight that represents the probability that the user travels from one web page 127 to another.

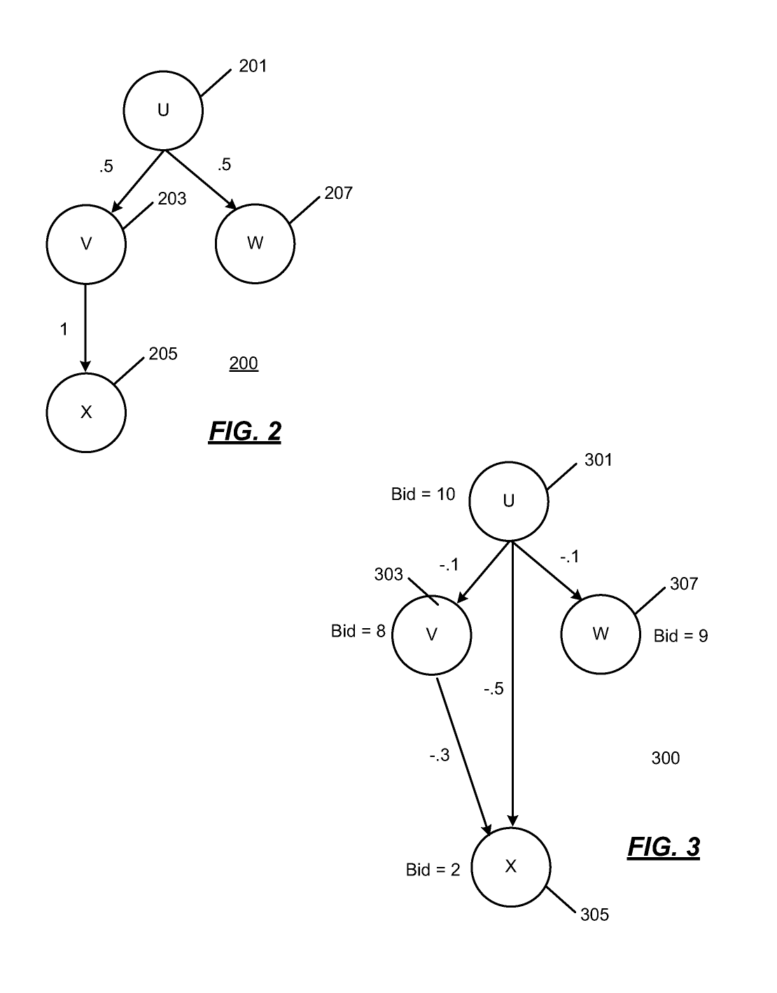

FIG. 2 is an illustration of an example browse graph 200. The browse graph 200 has four nodes that each corresponds to a web page 127. The node 201 corresponds to the web page “U”, the node 203 corresponds to the web page “V”, the node 205 corresponds to the web page “X”, and the node 207 corresponds to the web page “W”. A weight of 0.5 on both of the directed edges from the node 201 indicates that a user at the web page U has a 50% probability of visiting the web page V and a 50% probability of visiting the web page W. The weight of 1 on the directed edge from the node 203 indicates that a user at the web page V has a 100% probability of visiting the web page X. The browse graph may be generated by the advertisement server 160 based on past browsing histories of one or more users, for example.

The advertisers 125 may receive a browse graph, and may generate a bid for some or all of the web pages 127 represented by the nodes in the browse graph. The bids may be received by the advertisement server 160 and stored in the bid storage 165.

Along with the bids 138, the advertisers 125 may provide one or more externalities 137. In some implementations, the externalities 137 may be in the form of a one or more discount functions. The discount function for an advertiser 125 may take as an input the browse session data 111 associated with a request for an advertisement 135, and may return a discount for the bid associated with the advertiser 125. The externality engine 170 may use the determined discount to select an advertisement 135 to return in response to the request for an advertisement. Alternatively or additionally, the externalities 137 may be generated for the advertisers 125 by the externality engine 170.

In other implementations, the externalities 137 may be values that the externality engine 170 can deduct from a bid 138 associated with an advertiser 125 based on the browse session data 111 associated with a request for an advertisement 135. For example, for externalities 137 related to advertisements 135 of the advertiser 125 that have been shown in the browse session, the externalities 137 may specify that the bid 138 for the advertiser 125 be discounted by one, or some other value, for every advertisement 135 that the user has already viewed from the advertiser 125 as indicated by the browse session data 111. For externalities 137 related to competitors of the advertiser 125, the externalities 137 may specify that the bid 138 for the advertiser 125 be discounted by one, or some other value, for every advertisement 135 that the user has viewed from a competitor of the advertiser 125 as indicated by the browse session data 111. For externalities 137 related to domains or web pages 127 that a user has visited, the externalities 137 may specify that the bid 138 for the advertiser 125 be discounted by one, or some other value, for every specified web page 127 or domain that that the user has visited during the browse session as indicated by the browse session data 111. When a request for an advertisement 135 is received, the externality engine 170 may discount the bids by subtracting the values specified by the externalities 137 from each bid according to the browse session data 111. The advertisement server 160 may then provide an advertisement 135 associated with the advertiser 125 with the maximum discounted bid.

In some implementations, the externalities 137 and bids 138 for an advertiser 125 may be provided as a bid graph. A bid graph may include a node for each of the web pages 127 in the browse graph, and each node may be associated with a bid 138. The bid graph may further have edges between the nodes with weights that correspond to externalities 137. The externality engine 170 may discount a bid 138 for an advertiser 125 using the bid graph and the browse session data 111.

FIG. 3 is an illustration of an example bid graph 300. In the example shown, the bid graph 300 may be for externalities 137 related to advertisements already viewed from the advertiser 125. The bid graph 300 includes a node 301 that corresponds to the web page U, a node 303 that corresponds to the web page V, a node 307 that corresponds to the web page W, and a node 305 that corresponds to the web page X. As illustrated, the advertiser 125 has provided a bid 138 of 10 for the web page U, a bid 138 of 8 for the web page V, a bid 138 of 9 for the web page W, and a bid 138 of 2 for the web page X.

The externalities 137 may include weights on the edges between the nodes of the bid graph 300. The weight of 0.1 on the edge between the node 301 and the node 303 indicates that the bid 138 associated with the web page V may be discounted by −0.1 if the browse session data 111 indicates that the user has already viewed an advertisement 135 associated with the advertiser 125 at the web page U. The weight of 0.1 on the edge between the node 301 and the node 307 indicates that the bid 138 associated with the web page W may be discounted by −0.1 if the browse session data 111 indicates that the user has already viewed an advertisement 135 associated with the advertiser 125 at the web page U. The weight of −0.5 on the edge between the node 301 and the node 305 indicates that the bid associated with the web page X may be discounted by −0.5 if the browse session data 111 indicates that the user has already viewed an advertisement 135 associated with the advertiser 125 at the web page U. The weight of −0.3 on the edge between the node 303 and the node 305 indicates that the bid associated with the web page X may be discounted by −0.3 if the browse session data 111 indicates that the user has already viewed an advertisement 135 associated with the advertiser 125 at the web page V.

The externality engine 170 may discount the bid 138 associated with an advertiser based on the externalities 137 associated with the edges in the bid graph. In some implementations, the discounts applied to a bid may be cumulative. Thus, for example, with respect to the bid graph 300, the externality engine 170 may determine a discount for a bid 138 for the web page X. If the browse session data 111 indicates that the user viewed an advertisement 135 associated with the advertiser 125 at the web page U and the web page V, the externality engine 170 may determine the discount by adding the weights between the nodes 301, 303, and 305. Thus, the total discount applied is −0.4 (=−0.1+−0.3), for a discounted bid of 1.6 (=2 −0.4).

In some implementations, the externalities 137 may be, or comprise, a competitor graph. A competitor graph may include a node for the advertiser 125 and each competitor of the advertiser 125. The nodes may be connected by edges and each edge may have a weight. The weight on an edge of the graph may correspond to the externalities 137 associated with viewing an advertisement 135 from the competitors of the advertiser 125 corresponding to the nodes connected by the edge.

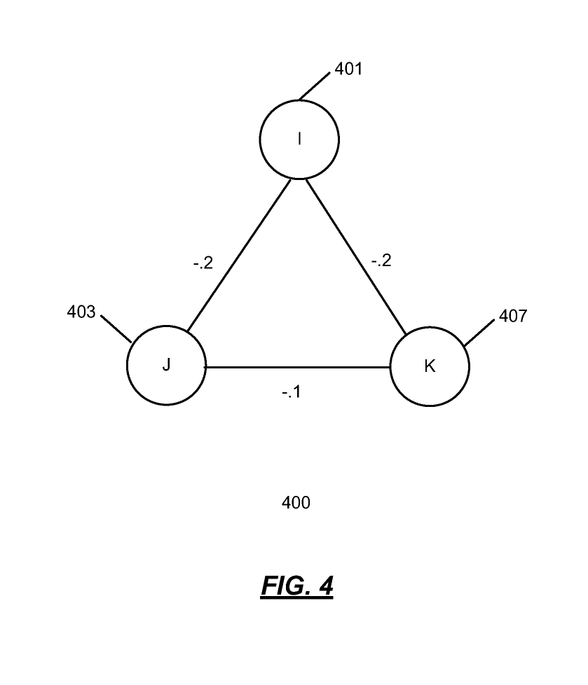

FIG. 4 is an illustration of an example competitor graph 400. The competitor graph 400 may have been provided by an advertiser “I”, and the competitors of the advertiser I may be the advertisers “J” and “K”. The competitor graph 400 has a node 401 corresponding to the advertiser I, a node 403 corresponding to the advertiser J, and a node 407 corresponding to the advertiser K.

The weight of −0.2 on the edge between the node 401 and the node 403 indicates that a bid 138 for the advertiser I may be discounted by −0.2 if the browse session data 111 indicates that an advertisement 135 from the advertiser J has already been shown to the user. The weight of −0.2 on the edge between the node 401 and the node 407 indicates that a bid 138 for the advertiser I may be discounted by −0.2 if the browse session data 111 indicates that an advertisement 135 from the advertiser K has already been shown to the user. The weight of −0.1 on the edge between the node 403 and the node 407 indicates that a bid 138 for the advertiser I may be additionally discounted by −0.1 if the browse session data 111 indicates that an advertisement 135 from the both of the advertisers J and K have already been shown to the user.

A graph similar to the competitor graph may be used to represent externalities 137 related to domains or web pages 127 that have been visited by a user during a browse session. However, rather than each node representing a competitor advertiser 125, each node may represent a web page or domain with an associated externality 137.

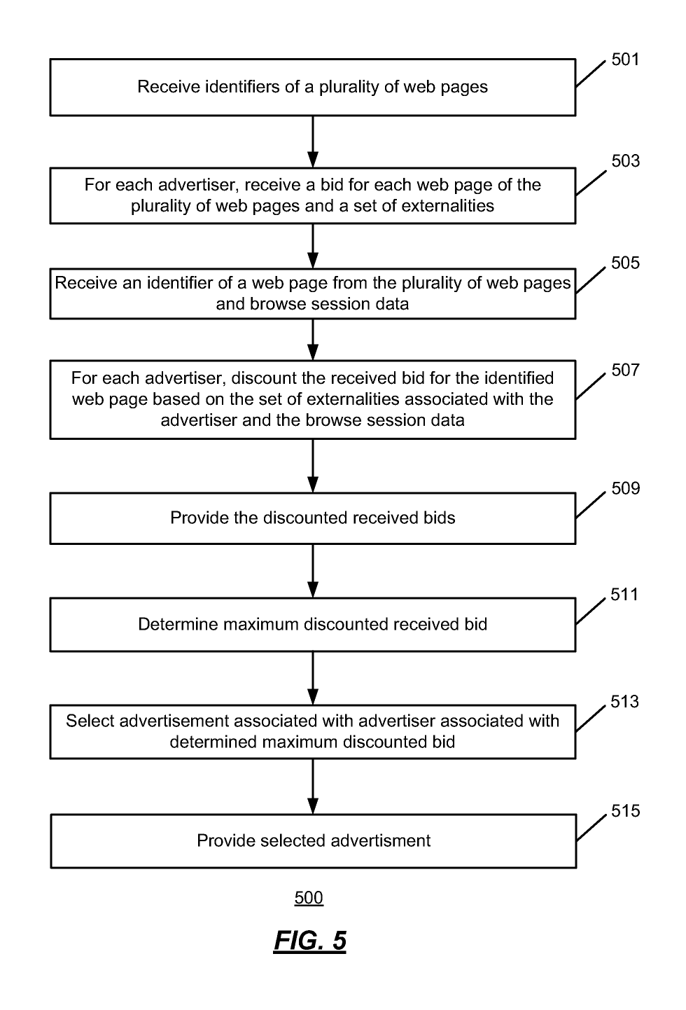

FIG. 5 is an operational flow of an implementation of a method 500 for discounting bids based on externalities. The method 500 may be implemented by the externality engine 170 of the advertisement server 160, for example.

Identifiers of a plurality of web pages are received at 501. In an implementation, the identifiers of a plurality of web pages 127 may be a browse graph and may be received by the externality engine 170 of the advertisement server 160.

For each advertiser of a plurality of advertisers, a bid is received for each web page in the plurality of web pages and a set of externalities at 503. The bids may be received by the externality engine 170 of the advertisement server 160 and may be stored in the bid storage 165. In some implementations, each bid may be to show an advertisement 135 associated with the advertiser 125 on or with a web page 127.

The set of externalities 137 may be generated by an advertiser 125 and may include externalities related to advertisements 135 from the advertiser 125 already shown, externalities related to advertisements 135 the competitors of the advertiser 125 already shown, and externalities related to web pages or domains visited by a user. The externalities may include a discount function, a bid graph, or a competitor graph, for example. In some implementations, the externalities 137 may be generated for each advertiser 125.

An identifier of a web page from the plurality of web pages and browse session data are received at 505. The identifier of a web page 127 and the browse session data 111 may be received by the by the externality engine 170 of the advertisement server 160. The identifier of a web page 127 and the browse session data 111 may be received as part of a request for an advertisement 135. In some implementations, the browse session data 111 may include identifiers of web pages 127 that were visited during the browse session, and identifiers of advertisements 135 that were provided during the browse session.

For each advertiser, the received bid for the advertiser is discounted based on the set of externalities associated with the advertiser and the browse session data at 507. The received bids 138 may be discounted by the externality engine 170 of the advertisement server 160.

The discounted bids are provided at 509. The discounted bids may be provided to the advertisement server 160 by the externality engine 170. A maximum discounted bid is determined at 511. The maximum discounted bid may be determined by the advertisement server 160 from the discounted bids.

An advertisement associated with the advertiser associated with the maximum discounted bid is selected at 513. The advertisement 135 may be selected from the advertisement storage 185 by the advertisement server 160. The selected advertisement is provided at 515. The selected advertisement 135 may be provided by the advertisement server 160 to a client device 110. The client device 110 may present to advertisement 135 to a user along with a web page 127.

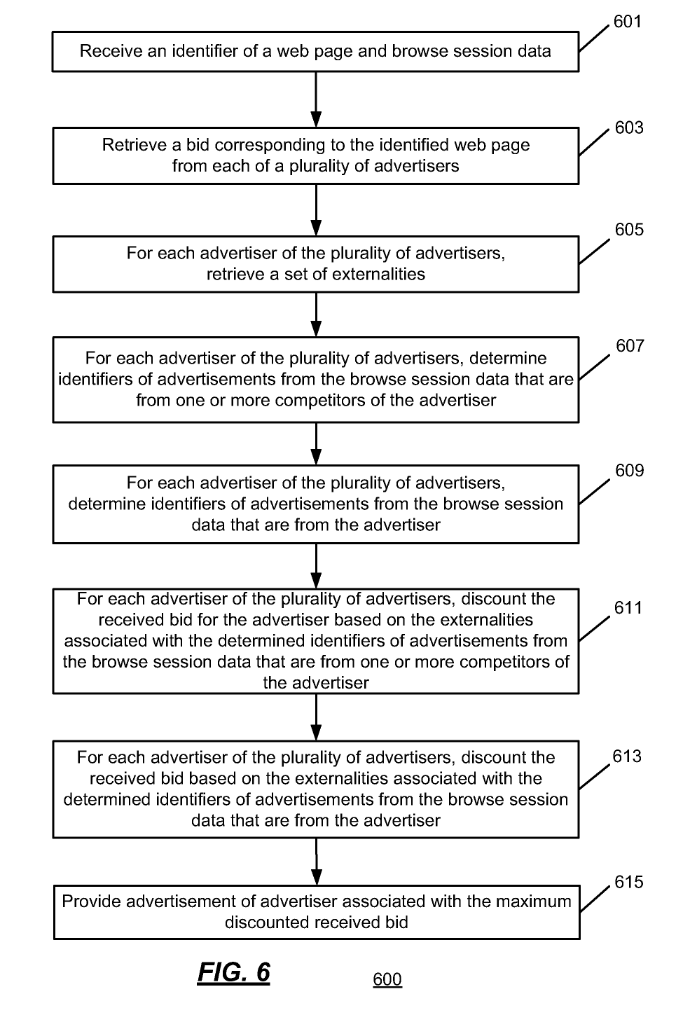

FIG. 6 is an operational flow of an implementation of a method for discounting bids based on externalities. The method 600 may be implemented by the externality engine 170 of the advertisement server 160, for example.

An identifier of a web page and browse session data are received at 601. The identifier and browse session data 111 may be received by the externality engine 170 of the advertisement server 160. The browse session data 111 may include identifiers of web pages and identifiers of advertisements that have been previously viewed or visited by a user during a browse session.

Bids corresponding to the identified web page are retrieved at 603. The bids may be retrieved by the externality engine 170 from the bid storage 165. Each bid may be associated with an advertiser 125 of a plurality of advertisers 125.

For each of the plurality of advertisers, a set of externalities associated with the advertiser is retrieved at 605. The sets of externalities 137 may be retrieved by the externality engine 170 from the externality storage 175. The set of externalities 137 for an advertiser 125 may include externalities associated with advertisements 135 from one or more competitors of the advertiser 125 and externalities 137 associated with advertisements 135 from the advertiser.

For each of the advertisers, identifiers of advertisements from the browse session data that are from one or more competitors of the advertiser are determined at 607. The identifiers may be determined by the externality engine 170. For each of the advertisers, identifiers of advertisements from the browse session data that are from the advertiser are determined at 609. The identifiers may be determined by the externality engine 170.

For each advertiser, the received bid for the advertiser is discounted based on the externalities associated with the determined identifiers of advertisements from the browse session data that are from one or more competitors of the advertiser at 611. The bids may be discounted by the externality engine 170.

For each advertiser, the received bid for the advertiser is discounted based on the externalities associated with the determined identifiers of advertisements from the browse session data that are from the advertiser at 613. The bids may be discounted by the externality engine 170.

An advertisement associated with the advertiser associated with the maximum discounted bid is provided at 615. The advertisement 135 may be retrieved from the advertisement storage 185 and provided by the advertisement server 160 to a user at a client device 110.

FIG. 7 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by computing device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
for each advertiser of a plurality of advertisers, receiving a bid for each web page of a plurality of web pages at a computing device;
for each advertiser of the plurality of advertisers, receiving a set of externalities associated with the advertiser at the computing device;
receiving an identifier of a web page from the plurality of web pages and browse session data at the computing device;
for each advertiser of the plurality of advertisers, discounting the received bid for the identified web page from the advertiser based on the set of externalities associated with the advertiser and the browse session data by the computing device; and
providing the discounted received bids by the computing device.

2. The method of claim 1, further comprising:
determining a maximum discounted bid; and
providing an identifier of the advertiser associated with the maximum discounted bid.

3. The method of claim 2, further comprising:
selecting an advertisement associated with the advertiser identified by the provided identifier of the advertiser; and
providing the selected advertisement.

4. The method of claim 1, wherein the plurality of web pages comprises a browse graph.

5. The method of claim 1, wherein the set of externalities for an advertiser comprises one of externalities associated with advertisements from the advertiser, externalities associated with advertisements from at least one competitor of the advertiser, or externalities associated with at least one web page of the plurality of web pages.

6. The method of claim 1, wherein the browse session data comprises identifiers of web pages from the plurality of web pages, and identifiers of advertisements.

7. The method of claim 6, wherein the set of externalities for an advertiser comprises externalities associated with advertisements from one or more competitors of the advertiser, and discounting the received bid for the identified web page from the advertiser based on the set of externalities and the browse session data comprises:
determining identifiers of advertisements from the browse session data that are from at least one competitor of the advertiser; and
discounting the received bid based on the externalities associated with the determined advertisements from the browse session data that are from at least one competitor of the advertiser.

8. The method of claim 6, wherein the set of externalities for an advertiser comprises at least one externality associated with advertisements from the advertiser, and discounting the received bid for the identified web page from the advertiser based on the set of externalities and the browse session data comprises:
determining identifiers of advertisements from the browse session data that are from the advertiser; and
discounting the received bid based on the externalities associated with the determined advertisements from the browse session data that are from the advertiser.

9. The method of claim 6, wherein the set of externalities for an advertiser comprises one or more externalities associated with one or more web pages of the plurality of web pages, and discounting the received bid for the identified web page from the advertiser based on the set of externalities and the browse session data comprises:
determining identifiers of web pages from the browse session that correspond to the one or more web pages associated with the one or more externalities; and
discounting the received bid based on the one or more externalities corresponding to the determined identifiers of web pages.

10. A method comprising:
receiving an identifier of a web page from a plurality of web pages and browse session data at a computing device;
retrieving a plurality of bids corresponding to the identified web page by the computing device, wherein each bid is associated with an advertiser of a plurality of advertisers;
for each advertiser of the plurality of advertisers, retrieving a set of externalities associated with the advertiser by the computing device;
for each advertiser of the plurality of advertisers, discounting the bid associated with the advertiser based on the set of externalities associated with the advertiser and the browse session data by the computing device;
determining a maximum discounted bid by the computing device;
selecting an advertisement associated with the advertiser associated with the determined maximum discounted bid by the computing device; and
providing the selected advertisement by the computing device.

11. The method of claim 10, wherein the plurality of web pages comprises a browse graph.

12. The method of claim 10, wherein the set of externalities for an advertiser comprises one of externalities associated with advertisements from the advertiser, externalities associated with advertisements from one or more competitors of the advertiser, or externalities associated with one or more web pages of the plurality of web pages.

13. The method of claim 10, wherein the browse session data comprises identifiers of web pages from the plurality of web pages, and identifiers of advertisements.

14. The method of claim 13, wherein the set of externalities for an advertiser comprises externalities associated with advertisements from one or more competitors of the advertiser, and discounting the received bid for the identified web page from the advertiser based on the set of externalities and the browse session data comprises:
determining identifiers of advertisements from the browse session data that are from one or more competitors of the advertiser; and
discounting the received bid based on the externalities associated with the determined advertisements from the browse session data that are from one or more competitors of the advertiser.

15. The method of claim 13, wherein the set of externalities for an advertiser comprises one or more externalities associated with advertisements from the advertiser, and discounting the received bid for the identified web page from the advertiser based on the set of externalities and the browse session data comprises:
determining identifiers of advertisements from the browse session data that are from the advertiser; and
discounting the received bid based on the externalities associated with the determined advertisements from the browse session data that are from the advertiser.

16. The method of claim 13, wherein the set of externalities for an advertiser comprises one or more externalities associated with one or more web pages of the plurality of web pages, and discounting the received bid for the identified web page from the advertiser based on the set of externalities and the browse session data comprises:
determining identifiers of web pages from the browse session that correspond to the one or more web pages associated with the one or more externalities; and
discounting the received bid based on the one or more externalities corresponding to the determined identifiers of web pages.

17. A system comprising:
at least one computing device; and
an externality engine adapted to:
receive an identifier of a web page from a plurality of web pages and browse session data, wherein the browse session data comprises identifiers of web pages and identifiers of advertisements;
retrieve a plurality of bids corresponding to the identified web page, wherein each bid is associated with an advertiser of a plurality of advertisers;
for each advertiser of the plurality of advertisers, retrieve a set of externalities associated with the advertiser, wherein the set of externalities for an advertiser comprises externalities associated with advertisements from one or more competitors of the advertiser and externalities associated with advertisements from the advertiser;
for each advertiser of the plurality of advertisers, determine identifiers of advertisements from the browse session data that are from one or more competitors of the advertiser;
for each advertiser of the plurality of advertisers, determine identifiers of advertisements from the browse session data that are from the advertiser;
for each advertiser of the plurality of advertisers, discount the received bid for the advertiser based on the externalities associated with the determined identifiers of advertisements from the browse session data that are from one or more competitors of the advertiser;
for each advertiser of the plurality of advertisers, discount the received bid for the advertiser based on the externalities associated with the determined identifiers of advertisements from the browse session data that are from the advertiser;
determine a maximum discounted bid;
select an advertisement associated with the advertiser associated with the determined maximum discounted bid by the computing device; and
provide the selected advertisement.

18. The system of claim 17, wherein the plurality of web pages comprises a browse graph.

19. The system of claim 17, wherein the externality engine is further adapted to receive the plurality of bids from the plurality of advertisers.

20. The system of claim 17, wherein the externality engine is further adapted to receive the set of externalities from each of the plurality of advertisers.
